(19) United States
(12) Patent Application Publication
(10) Pub. No.: US 2026/0140038 A1
(43) Pub. Date: May 21, 2026

(54) OPTICAL ISOLATOR STABILIZED LASER OPTICAL PARTICLE DETECTOR SYSTEMS AND METHODS

(71) Applicant: PARTICLE MEASURING SYSTEMS, INC., Niwot, CO (US)

(72) Inventors: Brian A. KNOLLENBERG, Niwot, CO (US); Dwight SEHLER, Niwot, CO (US); Saeid ROSTAMI, Niwot, CO (US)

(73) Assignee: PARTICLE MEASURING SYSTEMS, INC., Niwot, CO (US)

(21) Appl. No.: 19/394,549

(22) Filed: Nov. 19, 2025

Related U.S. Application Data
(63) Continuation of application No. 17/950,334, filed on Sep. 22, 2022, now abandoned.
(60) Provisional application No. 63/247,449, filed on Sep. 23, 2021.

(51) Int. Cl. G01N 15/14; G02F 1/09

(52) U.S. Cl. CPC G01N 15/14; G02F 1/093; G01N 2015/1486

(57) ABSTRACT

A particle detection system may include a laser optical source providing a beam of electromagnetic radiation, one or more beam shaping elements for receiving the beam of electromagnetic radiation, an optical isolator disposed in the path of the beam, between the laser source and the one or more beam shaping elements, a particle interrogation zone disposed in the path of the beam, wherein particles in the particle interrogation zone interact with the beam of electromagnetic radiation, and a first photodetector configured to detect light scattered and/or transmitted from the particle interrogation zone, a second photodetector configured to monitor power of the beam, and a controller configured to adjust the beam power based on a signal from the second photodetector, wherein the optical isolator is configured to filter optical feedback from the particle detection system out of an optical path leading to the second photodetector. The particle detection system may be configured to have a lower detection limit of 5 nm to 50 nm effective particle diameter. The laser optical source may have a laser power of 300 milliwatts to 100 watts.

### CROSS-REFERENCE TO RELATED APPLICATIONS

This application is a continuation of U.S. application Ser. No. 17/950,334, filed Sep. 22, 2022, which application claims the benefit of priority to U.S. Provisional Ser. No. 63/247,449 , filed Sep. 23, 2021, which are hereby incorporated by reference in their entireties.

### BACKGROUND OF INVENTION

Advancement of technologies requiring cleanroom conditions has resulted in the need for detection and characterization of increasingly smaller particles, and in ever lower concentrations. For example, microelectronic foundries pursue detection of particles less than 20 nm in size, and in some cases less than 10 nm in size, as they may affect the increasingly sensitive manufacturing processes and products. The concentrations of these particles in the process fluids may be such that even an occasional false positive may erroneously trigger time consuming and expensive manufacturing shutdowns. Furthermore, the need for aseptic processing conditions for manufacturing of pharmaceuticals and biomaterials requires accurate characterization of viable and non-viable particles to address compliance standard relating to health and human safety.

Typically, these industries rely on optical particle counters for detection and characterization of small particles. The ability to detect smaller particles requires improved lasers having increased laser powers and/or improved stability. Such systems are increasingly sensitive to optical feedback. Problems associated with such feedback include frequency instability, relaxation oscillations, amplified stimulated emission, false particle counts, and in some cases, optical damage.

Backscatter can occur, for example, as a result of any interface between two materials of differing indices of refractions such as the interface between air and an optical component, the interface between an optical component and water, etc. Furthermore, as a particle counter is operated over extended periods of time, it is possible for material or debris to progressively accumulate on surfaces in the optical path, resulting in increased backscatter, optical emission and increased instability of the particle counter data. The optical path contamination can be from airborne molecular contamination, photochemical reactions, particle contamination, and/or contamination residue accumulation inside the fluid flow path. Additionally or alternatively, molecular scatter from a fluid being analyzed for particles can make its way back to the laser. This type of backscatter is sometimes referred to as “noise”.

In some instances, noise due to backscatter may result in abnormal electronic signals whose amplitude can exceed a particle detection threshold, resulting in particle detection false counts. This phenomenon has become particularly important as the particles of interest have become smaller, because the scattered light signal decreases as 1/d\hat{ }, where d is the diameter of the particle. Thus, detection of very small particles requires greater laser stability to avoid creating electronic signals which exceed the particle detection threshold in the absence of particles passing through the beam.

Thus, it can be seen from the foregoing that there is a need in the art for systems and methods that provide reliable and repeatable optical sensing of particles having small size dimensions.

### SUMMARY OF THE INVENTION

Provided herein are systems and methods for optical isolator stabilized laser optical particle detectors. The disclosed systems and methods may protect the laser optical particle detector systems from potential noise sources such as backscatter due to interfaces between materials in the optical path of the beam, backscatter due to contamination of optical components, and/or molecular scatter from the fluid in the particle interrogation region from reaching the laser. The functional benefits of these improvements may include improved data quality, enhanced sensitivity and longer laser life and system expectancies.

In some embodiments, a Faraday isolator's ability to transmit light in one direction with high transmittance, while preventing transmission of light traveling in the opposite direction, can be employed to reduce the negative effects of optical feedback in modern, high sensitivity optical particle detectors.

In one embodiment, a particle detection system may comprise a laser optical source providing a beam of electromagnetic radiation, one or more beam shaping elements for receiving the beam of electromagnetic radiation, an optical isolator disposed in the path of the beam, between the laser source and the one or more beam shaping elements, a particle interrogation zone disposed in the path of the beam, wherein particles in the particle interrogation zone interact with the beam of electromagnetic radiation; and one or more photodetectors configured to detect light scattered and/or transmitted from the particle interrogation zone.

In one embodiment, a particle detection system comprises a laser optical source providing a beam of electromagnetic radiation, one or more beam shaping elements for receiving the beam of electromagnetic radiation, an optical isolator disposed in the path of the beam, between the laser source and the one or more beam shaping elements, wherein the optical isolator provides for a transmission of reflected, scattered or emitted light from the system to the laser optical source of less than or equal to 10%, a particle interrogation zone disposed in the path of the beam, wherein particles in the particle interrogation zone interact with the beam of electromagnetic radiation, and a photodetector configured to detect light scattered and/or transmitted from the particle interrogation zone. Preferably, in some embodiments, the particle detection system may be configured to have a lower detection limit (e.g., the smallest particle size that can be reliably detected) of 5 nm to 50 nm effective particle diameter. In some embodiments, the particle detection system may be configured to have a lower detection limit of 20 nm to 50 nm effective particle diameter. The laser optical source may have a laser power of 300 milliwatts to 100 watts.

In one embodiment, a particle detection system comprises a laser optical source providing a beam of electromagnetic radiation, one or more beam shaping elements for receiving the beam of electromagnetic radiation, an optical isolator disposed in the path of the beam, between the laser source and the one or more beam shaping elements, a particle interrogation zone disposed in the path of the beam, wherein particles in the particle interrogation zone interact with the beam of electromagnetic radiation; a first photodetector configured to detect light scattered and/or transmitted from the particle interrogation zone, a second photodetector configured to monitor power of the beam; and a controller configured to adjust the beam power based on a signal from the second photodetector, wherein the optical isolator is configured to filter optical feedback from the particle detection system out of an optical path leading to the second photodetector. The particle detection system may be configured to have a lower detection limit of 5 nm to 50 nm effective particle diameter. The laser optical source may have a laser power of 300 milliwatts to 100 watts.

In one embodiment, a particle detection system comprises, a laser optical source providing a beam of electromagnetic radiation, the laser optical source having a housing, one or more beam shaping elements for receiving the beam of electromagnetic radiation, an optical isolator disposed in the path of the beam, between the laser source and the one or more beam shaping elements, wherein the optical isolator is disposed within the housing of the laser optical source, a particle interrogation zone disposed in the path of the beam, wherein particles in the particle interrogation zone interact with the beam of electromagnetic radiation, and a photodetector configured to detect light scattered and/or transmitted from the particle interrogation zone. The particle detection system may be configured to have a lower detection limit of 5 nm to 50 nm effective particle diameter. The laser optical source may have a laser power of 300 milliwatts to 100 watts.

In one embodiment, the laser optical source has a laser power of 300 milliwatts to 10 watts. In one embodiment, the laser optical source has a laser power of 500 milliwatts to 10 watts.

In one embodiment, the particle detection system may be configured to have a lower detection limit of 9 nm to 50 nm effective particle diameter. In one embodiment, the particle detection system may be configured to have a lower detection limit of 15 nm to 50 nm effective particle diameter.

In some embodiments, the optical isolator provides for a transmission of said beam of electromagnetic radiation from the laser optical source greater than or equal to 50%. In some embodiments, the optical isolator provides for a transmission of reflected, scattered or emitted light from the system to the laser optical source of less than or equal to 10%. In some embodiments, the optical isolator prevents or reduces optical feedback in said laser optical source.

In some embodiments, the optical isolator reduces instability of the laser optical source caused by back reflection or scattered light by downstream components or the measurement fluid in the particle interrogation zone. In some embodiments, the optical isolator comprises a Faraday rotator. In one embodiment, the optical isolator is free standing. In an alternate embodiment, the optical isolator is integrated into a housing of the laser optical source.

In some embodiments, the optical isolator is a polarization dependent optical isolator. For example, in one embodiment, the optical isolator comprises an input polarizer, a Faraday rotator and an output polarizer. The input polarizer may be positioned between the laser optical source and the Faraday rotator and the output polarizer may be positioned between the Faraday rotator and the particle interrogation zone.

In some embodiments, the Faraday rotator provides for nonreciprocal rotation while maintaining a linear polarization of said beam of electromagnetic radiation. For example, the Faraday rotator (or a series thereof) rotates the plane of polarization of the beam of electromagnetic radiation by 45° to 90°.

In some embodiments, the output polarizer is configured to transmit the beam of electromagnetic radiation passing from the Faraday rotator toward the particle interrogation zone. The input polarizer may be configured to prevent transmission of light passing from Faraday rotator toward the laser optical source.

In some embodiments, the optical isolator is a polarization independent optical isolator. For example, in one embodiment, the optical isolator comprises an input birefringent wedge, a Faraday rotator and an output birefringent wedge. The input birefringent wedge may be positioned between the laser optical source and the Faraday rotator and the output birefringent wedge may be positioned between the Faraday rotator and the particle interrogation zone. In one embodiment, the input birefringent wedge is configured to split the beam from the laser optical source into a first component beam and second component beam, wherein the first component beam corresponds to the vertical component of the beam and the second component beam corresponds to the horizontal component of the beam. The output birefringent wedge may be configured to recombine the first and second component beams after passing through the Faraday rotator.

In one embodiment, the Faraday rotator is configured to rotate the planes of polarization of the first and second component beams. In one embodiment, the system comprises a first collimator positioned between the optical isolator and the laser optical source and a second collimator position between the optical isolator and the particle interrogation zone.

In one embodiment, the laser optical source is a solid state laser. In one embodiment, the laser optical source is a laser diode or laser oscillator.

In one embodiment, the system comprises a plurality of laser optical sources and a plurality of optical isolators.

In one embodiment, the laser optical source provides light having a radiant power selected from the range of 0.01 to 200 W. In one embodiment, the laser optical source provides light having a radiant wavelength selected from the range 160 nm to 1500 nm.

In one embodiment, the one or more beam shaping elements comprise at least a focusing element for focusing light on to said particle interrogation zone. In one embodiment, the system comprises a mirror or other non-beam shaping component disposed in the path of the beam between the optical isolator and the one or more beam shaping elements.

In one embodiment, the system comprises a half wave plate or a ¼ wave plate in the path of the beam after the optical isolator to restore the polarization of the beam or deliver circularly polarized light to downstream components.

In one embodiment, the particle interrogation zone comprises a flow cell for flowing a fluid containing the particles. In some embodiments, the particle interrogation zone comprises a surface. For example, in one embodiment the particle interrogation zone comprises a surface of a semiconductor wafer.

In one embodiment, the photodetector comprises one or more two dimensional photodetector arrays. In one embodiment, the photodetector is configured to detect light scattered by particles in the particle interrogation zone. In one embodiment, the photodetector is configured to detect light transmitted through the particle interrogation zone.

In one embodiment, the laser optical source has an exit window, and the beam path between the window and the optical isolator is less than 500 mm. In one embodiment, the laser optical source has an exit window, and the beam path between the window and the optical isolator is less than 300 mm. In one embodiment, the laser optical source has an exit window, and the beam path between the window and the optical isolator is less than 100 mm.

In one embodiment, the system is configured to detect particles having a concentration in a fluid, the concentration being 1 to 100,000 particles per liter of the fluid for particles having an effective diameter greater than or equal to 20 nm. In one embodiment, the system is configured to detect particles having a concentration in a fluid, the concentration being 10 to 100,000 particles per liter of the fluid for particles having an effective diameter greater than or equal to 20 nm. the system is configured to detect particles having a concentration in a fluid, the concentration being 100 to 100,000 particles per liter of the fluid for particles having an effective diameter greater than or equal to 20 nm.

In one embodiment, the laser optical source has a housing, and wherein the second photodetector, controller, and optical isolator are disposed within the housing of the laser optical source.

In one embodiment, a method of detecting particles comprises producing a beam of electromagnetic radiation, passing the beam through an optical isolator, shaping the beam via one or more beam shaping elements, directing the shaped beam toward a particle interrogation zone, passing particles through the particle interrogation zone, wherein the beam interacts with the particles in the particle interrogation zone, and detecting at least a portion of light scattered and/or transmitted from the particle interrogation region, wherein the optical isolator provides for a transmission of reflected, scattered or emitted light from the system to the laser optical source of less than or equal to 10%.

In one embodiment, a method of controlling an actively stabilized laser particle detection system comprises producing a beam of electromagnetic radiation via the actively stabilized laser, the beam having a beam power, passing the beam through an optical isolator, shaping the beam via one or more beam shaping elements, directing the shaped beam toward a particle interrogation zone, passing particles through the particle interrogation zone, wherein the beam interacts with the particles in the particle interrogation zone, and detecting at least a portion of light scattered and/or transmitted from the particle interrogation region via a first photodetector, monitoring the beam power via a second photodetector, filtering, via an optical isolator, optical feedback from the particle detection system out of an optical path leading to the second photodetector, adjusting the beam power via a controller in response to the monitoring and filtering steps.

In one embodiment, the method comprises preventing or reducing optical feedback into the light source via the optical isolator. In one embodiment, the optical isolator comprises a Faraday rotator.

In one embodiment, the optical isolator is polarization dependent. For example, in one embodiment, passing the beam through the optical isolator comprises: linearly polarizing the beam via a first polarizing element; rotating the plane of polarization of the beam by 45°; and passing the beam through a second polarizing element, wherein the second polarizing element has a polarization axis aligned at 45° relative to a polarization axis of the first polarizing element.

In one embodiment, the method comprises passing light through the second polarizing element in the reverse direction to form polarized reverse light; rotating the plane of polarization of the polarized reverse light by 45°; and attenuating the reverse light via the first polarizing element.

In some embodiments, the optical isolator is polarization independent. For example, in one embodiment, the beam through the optical isolator comprises: passing the beam through a first birefringent wedge to form an e-ray and an o-ray; rotating the planes of polarization of the e-ray and the o-ray by 45° via the Faraday rotator; and recombining the e-ray and the o-ray via a second birefringent wedge. In one embodiment, the method comprises: passing light through the second birefringent wedge in the reverse direction to form a reverse e-ray and a reverse o-ray; rotating the planes of polarization of the reverse e-ray and the reverse o-ray by 45° via the Faraday rotator; and diverging the reverse e-ray and the reverse o-ray via the first birefringent wedge. In one embodiment, the method comprises attenuating the reverse e-ray and the reverse o-ray via a collimator.

In some embodiments, the method is for reducing noise in an optical particle counter. In some embodiments, the method is for increasing stability and lifetime of an optical particle counter.

The optical isolator stabilization systems and methods disclosed herein can be utilized in a broad array of particle detection systems. In one embodiment, the optical isolator stabilized particle detector is a scattering particle detector. In one embodiment, the optical isolator stabilized particle detector is a dark beam particle detector. In one embodiment, the optical isolator stabilized particle detector is a side-scattering particle detector. In one embodiment, the optical isolator stabilized particle detector is a forward-scattering particle detector. In one embodiment, the optical isolator stabilized particle detector is a differential particle detector. In one embodiment, the optical isolator stabilized particle detector is an interferometric particle detector. In one embodiment, the optical isolator stabilized particle detector is a pumped beam particle detector.

In one embodiment, a method of reducing false positive detection events in a particle detection system comprises: producing a beam of electromagnetic radiation via an actively stabilized laser, the laser having a laser power of 300 milliwatts to 100 watts; wherein the particle detection system is configured to have a lower detection limit of 5 nm to 50 nm effective particle diameter; passing the beam through an optical isolator; shaping the beam via one or more beam shaping elements; directing the shaped beam toward a particle interrogation zone, passing particles through the particle interrogation zone, wherein the beam interacts with the particles in the particle interrogation zone; detecting at least a portion of light scattered and/or transmitted from the particle interrogation region via a first photodetector; monitoring the beam power via a second photodetector; filtering, via an optical isolator, optical feedback from the particle detection system out of an optical path leading to the second photodetector; and adjusting the beam power via a controller in response to the monitoring and filtering steps.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 shows a plot of particle concentration vs. time. Time is shown on the X axis and particle concentration is shown on the Y axis. The plot shows data from two particle counter units sampling the same media.

FIG. 2 is a schematic diagram of the optical path of a polarization dependent optical isolator for light traveling in the laser emission direction in accordance with the present disclosure.

FIG. 3 is a schematic diagram of the optical path of a polarization dependent optical isolator for light traveling in the noise source direction in accordance with the present disclosure.

FIG. 4A is a schematic diagram of: the optical path of a polarization independent optical isolator for light traveling in the laser emission direction (above); and the optical path of a polarization independent optical isolator for light traveling in the noise source direction (below) in accordance with the present disclosure.

FIG. 4B is a schematic diagram of: the optical path of randomly polarized light traveling through one embodiment of an optical isolator in the laser emission direction (above); and the optical path of randomly polarized light traveling through the optical isolator in the noise source direction (below) in accordance with the present disclosure.

FIG. 5 is a schematic diagram of one embodiment of an optical isolator stabilized laser optical particle counter of the present disclosure.

FIG. 6 is a schematic diagram of one embodiment of an optical isolator including a polarizing beam splitter cube (PBS) and a quarter-wave plate arranged to prevent laser light from returning along the outbound path.

FIG. 7 is a schematic diagram of one embodiment of an acousto-optic isolator.

FIG. 8 is a schematic diagram of an actively stabilized laser, including beam power detection and a feedback control loop.

FIG. 9 is a flow diagram illustrating a potential route for false particle counts due to laser instability in an actively stabilizes laser particle counted system.

FIG. 10A is a plot of detected particle count vs. time. Time is shown on the X axis and particle count is shown on the Y axis. The plot shows numerous false positive detection events.

FIG. 10B is a plot of detected particle count vs. time. The data were collected after installing a Faraday isolator on the same instrument sampling the same deionized water media as FIG. 10A. Time is shown on the X axis and particle count is shown on the Y axis.

FIG. 11 is a plot of detected particle count vs. time. Time is shown on the X axis and particle count is shown on the Y axis. The plot shows numerous false positive detection events until a Faraday rotator is installed, at which point the false positive behavior of the device ceases.

FIG. 12 is a plot of detected particle count vs. time. Time is shown on the X axis and particle count is shown on the Y axis. The plot shows numerous false positive detection events.

FIG. 13 is a plot of detected particle count vs. time. The data were collected after installing a Faraday isolator on the same instrument sampling the same deionized water media as FIG. 12. Time is shown on the X axis and particle count is shown on the Y axis.

FIG. 14 is a plot of detected particle count vs. time. Time is shown on the X axis and particle count is shown on the Y axis. The plot shows numerous false positive detection events.

FIG. 15 is a plot of detected particle count vs. time. The data were collected after installing a Faraday isolator on the same instrument sampling the same deionized water media as FIG. 14. Time is shown on the X axis and particle count is shown on the Y axis.

FIG. 16 is a plot of detected particle count vs. time. The data were collected via the optical isolator-equipped device of FIG. 15 the same instrument sampling the same deionized water media as FIGS. 14 and 15. The data show continued operational stability of the device and the absence of significant false positive detection events.

FIG. 17 is schematic representation of a configuration for utilizing a randomly polarized optical source with a Faraday optical isolator.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

“Particles” refers to small objects which are often regarded as contaminants. A particle can be any material created by the act of friction, for example when two surfaces come into mechanical contact and there is mechanical movement. Particles can be composed of aggregates of material, such as dust, dirt, smoke, ash, water, soot, metal, oxides, ceramics, minerals, or any combination of these or other materials or contaminants. “Particles” may also refer to biological particles, for example, viruses, spores and microorganisms including bacteria, fungi, archaea, protists, other single cell microorganisms. In some embodiments, for example, biological particles are characterized by a size dimension (e.g., effective diameter) ranging from 0.1-15 μm, optionally for some applications ranging from 0.5-5 μm. A particle may refer to a small object which absorbs, emits or scatters light and is thus detectable by an optical particle counter. As used herein, “particle” is intended to be exclusive of the individual atoms or molecules of a carrier fluid, for example water, air, process liquid chemicals, process gases, etc. In some embodiments, particles may be initially present on a surface, such as a tools surface in a microfabrication facility, liberated from the surface and subsequently analyzed in a fluid. Some systems and methods are capable of detecting particles comprising aggregates of material having a size dimension, such as effective diameter, greater than 20 nm, 30 nm, 50 nm, 100 nm, 500 nm, 1 μm or greater, or 10 μm or greater. Some embodiments of the present invention are capable of detecting particles having a size dimension, such as effective diameter, selected from that range of 10 nm to 150 μm, optionally for some applications 10 nm to −10 μm, optionally for some applications 10 nm to −1 μm, and optionally for some applications 10 nm to −0.5 μm.

The expression “detecting a particle” broadly refers to sensing, identifying the presence of, counting and/or characterizing a particle, such as characterizing a particle with respect to a size dimension, such as effective diameter. In some embodiments, detecting a particle refers to counting particles. In some embodiments, detecting a particle refers to characterizing and/or measuring a physical characteristic of a particle, such as effective diameter, cross sectional dimension, shape, size, aerodynamic size, or any combination of these. In some embodiments, detection a particle is carried out in a flowing fluid, such as gas having a volumetric flow rate selected over the range of 0.05 CFM to 10 CFM, optionally for some applications 0.1 CFM to 5 CFM and optionally for some applications 0.5 CFM to 2 CFM. In some embodiments, detection a particle is carried out in a flowing fluid, such as liquid having a volumetric flow rate selected over the range of 1 to 1000 mL/min.

“Optical Particle Counter” or “particle counter” are used interchangeably and refer to a particle detection system that uses optical detection to detect particles, typically by analyzing particles in a fluid flow. Optical particle counters include liquid particle counters and aerosol particle counters, for example, including systems capable of detecting individual single particles in a fluid flow. Optical particle counters provide a beam of electromagnetic radiation (e.g. a laser) into the analysis area, where the beam interacts with any particles and then detects the particles based on scatter, emitted or transmitted light from the flow cell. Detection may focus on electromagnetic radiation that is scattered, absorbed, obscured and/or emitted by the particle(s). Various detectors for optical particle counters are known in the art, including for example, single detection elements (e.g., photodiode, photomultiplier tube, etc.), detector arrays, cameras, various detector orientations, etc. Optical particle counter includes condensation particle counters, condensation nuclei counters, split beam differential systems and the like. When used in the context of a condensation particle counter, the particle counter portion refers to the detection system (e.g. source of electromagnetic radiation, optics, filters, optical collection, detector, processor, etc.). In an embodiment, for example, an optical particle counter comprises a source for generating a beam of electromagnetic radiation, beam steering and/or shaping optics for directing and focusing the beam into a region where a fluid sample is flowing, for example a liquid or gas flowing through a flow cell. A typical optical particle counter comprises of a photodetector, such as optical detector array in optical communication with said flow cell, and collection optics for collecting and imagining electromagnetic radiation which is scattered, transmitted by or emitted by particles which pass through the beam. Particle counters may further comprise electronics and/or processors components for readout, signal processing and analysis of electrical signals produced by the photodetector including current to voltage converters, pulse height analyzers, and signal filtering and amplification electronics. An optical particle counter may also comprise a fluid actuation systems, such as a pump, fan or blower, for generating a flow for transporting a fluid sample containing particles through the detection region of a flow cell, for example, for generating a flow characterized by a volumetric flow rate. Useful flow rates for samples comprising one or more gases include a flow rate selected over the range of 0.05 CFM to 10 CFM, optionally for some applications 0.1 CFM to 5 CFM and optionally for some applications 0.5 CFM to 2 CFM. Useful flow rates for samples comprising one or more liquids include a flow rate selected over the range of 1 to 1000 mL/min.

Detecting and counting small particles (e.g., effective diameter less than 100 nm) in clean and ultraclean fluids in a manner that provides statistically significant data requires high signal-to-noise ratio (S/N). A high S/N ratio allows nanoparticles to be clearly detected above the noise floor. As used herein “statistically significant data” refers to detection of enough particles per unit time to be able to accurately assess contamination levels in the fluid. In some embodiments, high S/N does not relate to sizing accuracy directly. For example, in some optical particle counters the beam waist occupies a small fraction of the flow cell channel, and therefore, this approach monitors a subset of the total flow, such that it is possible for particles to pass through the edge of the beam where irradiance is less than the center. If a 50 nm particle passes through the outer edge of the beam, it may generate a signal similar to a 10 nm particle passing through the center of the beam. Therefore, it is possible for some optical particle counters to have high S/N and be able to detect, for example 20 nm particles, while not having very good sizing accuracy. In some of the present optical particle counters and methods a goal is to be able to count enough particles to provide a quantitative, statistically sound, assessment of contamination levels in ultrahigh purity fluids in the shortest period of time. For example, the current state of the art particle counter may require up to 40 minutes to count enough particles to provide a statistically appropriate concentration (acceptable relative standard deviation) measurement when monitoring a state of the art ultrapure water system. By improving and maintaining a high S/N through the present systems and methods, the time interval needed to measure this minimum statistically acceptable particle counts can be reduced by 10× or more. This provides value as it allows a user to identify deviations from process control limits more quickly.

The term “noise” refers to unwanted modifications of a signal (e.g. a signal of a photodetector) that interfere with the accuracy or precision of a particle detection system. Noise may derive from sources such as backscatter due to interfaces between materials in the optical path of the beam, backscatter due to contamination of optical components, and/or molecular scatter from the fluid in the particle interrogation region from reaching the laser. In some embodiments, noise due to backscatter may result in abnormal electronic signals whose amplitude can exceed a particle detection threshold, resulting in particle detection false counts.

The expression “high signal-to-noise ratio” refers to a signal-to-noise ratio of an optical particle detection system sufficient for accurate and sensitive detection of particles in a fluid flow, including particles characterized by a small physical dimension (e.g., an effective diameter of less than or equal to 200 nm, optionally for some embodiments less than or equal to 100 nm and optionally for some embodiments less than or equal to 50 nm). In an embodiment, “high signal-to-noise ratio” refers to a signal-to-noise ratio sufficiently high to sense particles characterized by a small physical dimension, such as particles having an effective diameter as low as 20 nm, optionally for some applications a diameter as low as 10 nm and optionally for some applications a diameter as low as 1 nm. In an embodiment, “high signal-to-noise ratio” refers to a signal-to-noise ratio sufficiently high to accurately detect and count particles with a false detection rate of less than or equal to 50 counts/L, for example, for detection of particles having an effective diameter selected over the range of 1-1000 nm. In an embodiment, “high signal-to-noise ratio” refers to a signal-to-noise ratio sufficiently high to provide a minimum statistically acceptable particle count in a timeframe at least a factor of 10× less than in a conventional optical particle counter. Systems and methods of the present disclosure may provide a high signal to noise ratio.

“Beam propagation axis” refers to an axis parallel to the direction of travel of a beam of electromagnetic radiation.

“Optical communication” refers to components which are arranged in a manner that allows light to transfer between the components.

“Optical axis” refers to a direction along which electromagnetic radiation propagates through a system.

“Photodetector array” refers to an optical detector capable of spatially resolving input signals (e.g., electromagnetic radiation) in two dimensions across an active area of the detector. A photodetector array is capable of generating an image, for example an image corresponding to an intensity pattern on the active area of the detector. In an embodiment, a photodetector array comprises an array of individual detector elements, also referred herein as pixels; for example: a two-dimensional array of photodetectors, a charge-coupled device (CCD) detector, a complementary metal-oxide-semiconductor (CMOS) detector, a metal-oxide-semiconductor (MOS) detector, an active pixel sensor, a microchannel plate detector, or a two-dimensional array of photodiodes.

“Light source” refers to a device or device component that is capable of delivering electromagnetic radiation to a sample. The term “light” is not limited to visible radiation, such as by a visible light beam, but is used in a broad sense to include any electromagnetic radiation also inclusive of visible radiation, ultraviolet radiation and/or infrared radiation. The optical source may be embodied as a laser or laser array, such as a diode laser, diode laser array, diode laser pumped solid state laser, LED, LED array, gas phase laser, laser oscillator, solid state laser, to name a few examples.

The term “electromagnetic radiation” and “light” are used synonymously in the present description and refer to waves of electric and magnetic fields. Electromagnetic radiation useful for the methods of the present invention include, but is not limited to ultraviolet light, visible light, infrared light, or any combination of these having wavelengths between about 100 nanometers to about 15 microns.

The term “particle interrogation zone” refers to a zone within a particle detection system where one or more particles interact with the incident beam and/or the pump beam to scatter light. In some embodiments, the particle interrogation zone may comprise a cuvette and/or a flow cell to constrain a particle-containing liquid flowing therethrough. In other embodiments, an unconstrained jet of particle-containing gas may flow through the particle interrogation zone. In still other embodiments, the particle interrogation zone may comprise a surface to be interrogated for particles.

The term “optical isolator” refers to an optical component which allows the transmission of light in one direction, but reduces or eliminates the transmission of light in the opposite direction. In some embodiments, for example, an optical isolator is configured to provide for a transmission of light from one or more laser optical sources of greater than or equal to 50%, optionally greater than or equal to 70%, optionally greater than or equal to 90% and optionally greater than or equal to 95%. In some embodiments, for example, an optical isolator is configured to provide for transmission of light from other elements of the particle counter to the one or more laser optical sources (i.e., back reflection transmission) of less than or equal to 20%, optionally less than or equal to 10%, optionally less than or equal to 5% and optionally less than or equal to 1%. In some embodiments, optical isolators of the present disclosure may provide as little as 0.001% back reflection transmission. Optical isolators of the present disclosure may operate via the Faraday effect to provide a non-reciprocal optical element in the path of the laser of a particle detector. The optical isolator can be provided anywhere downstream of the laser optical source, however it has been found that in some embodiments, configuring the particle detector such that the optical isolator is the first optical element downstream of the laser optical source may be particularly advantageous. As used herein, “downstream” refers to a component that is further away from the laser optical source along the optical path of the beam, as compared to another component. As used herein, “upstream” refers to a component that is closer to the laser optical source along the optical path of the beam, as compared to another component. In some embodiments, the optical isolator can be incorporated into the housing of the laser.

As used herein, the term actively stabilized laser means a laser optical light source controlled by a feedback control loop. The feedback control loop may include a dedicated photodetector configured to monitor the power of the laser beam produced by the laser. The feedback control system may also include a laser power controller configured to adjust the power of the produced beam in response to a signal received from the photodetector.

As used herein, the term “false positive detection event” means one or more signals generated by a particle detection system which incorrectly indicate detection of a particle.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

The disclosed systems and methods may employ an optical isolator between the high stability laser and the beam shaping optics in an optical particle counter, thereby preventing the coupling of stray light from the system back into the laser and potentially upsetting the power stabilizing systems contained therein. In some embodiments, the optical isolator may be a polarization dependent optical isolator. In other embodiments, the optical isolator may be a polarization independent optical isolator.

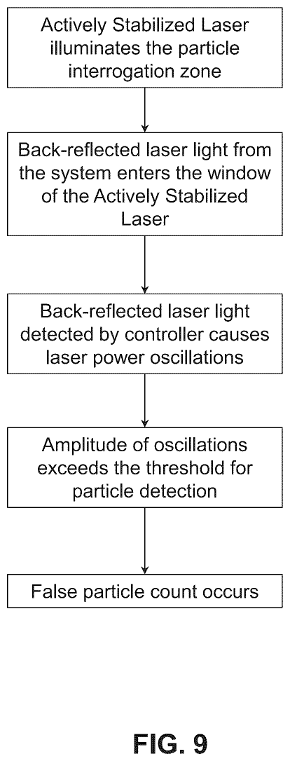

Detection of very small particles at low concentration in a fluid may require an actively stabilized laser as part of the particle detection system. The active stabilization, i.e., feedback control system to stabilize the power output of the laser, allows for more sensitive detection of particles. However, it may also introduce the potential for false particle counts. Turning now to FIG. 9, a flow chart illustrating one example of this unwanted false count behavior is shown. First, the actively stabilized laser illuminates the particle interrogation zone. The actively stabilized laser may include a photodetector to continuously monitor the power of the beam exiting the exit window of the laser, and a controller to adjust the power of the laser accordingly. Thus, under normal operating conditions, the power of the laser may be stable.

However, due to one or more sources of backscatter within the system, back-reflected light may make its way back into the laser widow of the actively stabilized laser. The back reflected light combines with the sample of the laser output, thereby indicating to the controller that, for example, the output power of the beam is too high, when in fact it is not. Thus, the controller may erroneously reduce the beam power. The detector monitoring the laser power may then detect this drop in beam power and the controller may respond by increasing beam power. In some embodiments, this phenomenon may cause oscillations of beam power inside the particle interrogation zone of sufficient amplitude to exceed the particle detection threshold at one or more photodetectors monitoring the particle interrogation zone. Thus, a false particle count may occur in the absence of particles in the interrogation zone, due only to back-reflected light finding its way back into the actively stabilized laser. In some embodiments, the systems and methods disclosed herein may address this problem.

### EXAMPLE 1—PROOF OF CONCEPT: NOISE REDUCTION IN PARTICLE DETECTOR IN OPERATION

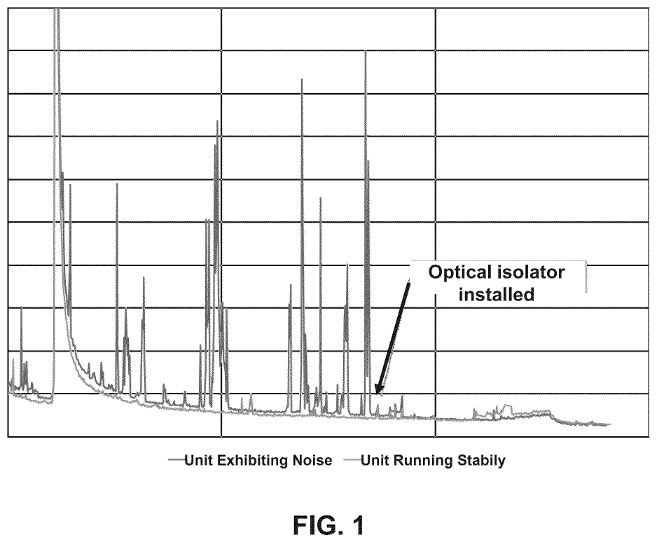

Turning now to FIG. 1, data demonstrating the efficacy of the systems and methods of the present disclosure is shown. Specifically, FIG. 1 shows a plot of particle concentration vs. time. Time is shown on the X axis and particle concentration is shown on the Y axis. The plot shows data from two particle counter units sampling the same media.

As can be seen, one of the units displays unstable operation wherein the photodetector senses optical fluctuations on the same magnitude as the level of light scattered by small particles, thereby generating a particle detection event, even though there is no particle present. This instability may be due to the factors discussed above (including contamination on optical components, molecular scatter from a fluid in the particle interrogation zone, interfaces between material having differing indices of refraction, etc.). At the point in time identified on the graph, an optical isolator in accordance with the present invention was installed. After optical isolator installation, the second unit appears to cease exhibiting signal noise and the particle concentration data of the two particle counters agree closely.

### EXAMPLE 2—POLARIZATION DEPENDENT ISOLATORS

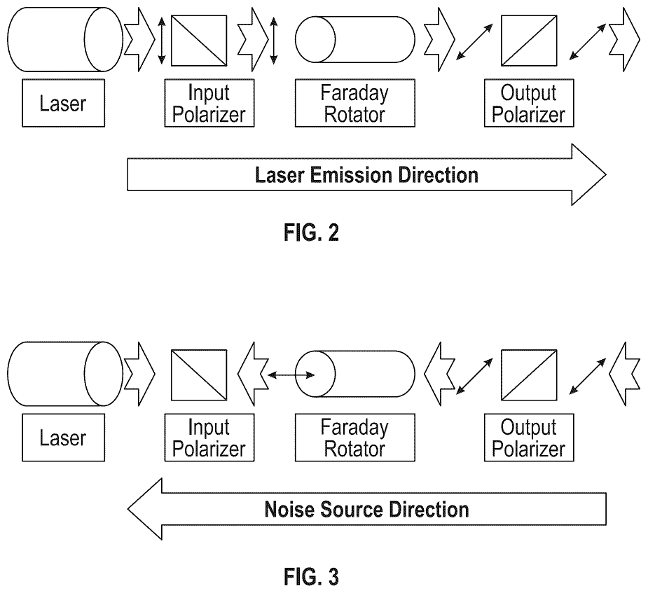

In some embodiments, a polarization dependent Faraday isolator consists of three main components, an input polarizer, a Faraday rotator and an output polarizer. As shown in FIG. 2, light traveling in the forward direction may pass through the input polarizer and becomes polarized in, for example, the vertical plane. Upon passing through the Faraday rotator, the plane of polarization will have been rotated 45° on axis. The output polarizer, which has been aligned with is axis of polarization at 45° relative to that of the input polarizer, will allow the light to pass unimpeded.

As shown in FIG. 3, light traveling in the reverse direction will pass through the output polarizer and become polarized at 45°. The light will then pass through the Faraday Rotator and experience an additional 45° of nonreciprocal rotation. The light is now polarized in the horizontal plane and will be rejected by the input polarizer which only allows light polarized in the vertical plane to pass unimpeded. Thus, light traveling in the upstream direction may be highly attenuated and the stability of the source laser may be improved.

It has been found that a Faraday Isolator's ability to provide nonreciprocal rotation while maintaining a linear polarization is what differentiates it from a λ/4 plate-polarizer type isolator, and allows it to provide higher isolation and greater stability. In some embodiments, a ½ wave plate can be added to the system to maintain input polarization to downstream components.

While the example depicted employs a single Faraday rotator configured to provide a 45° rotation of the plane of polarization in the forward direction, with input and output polarizers disposed according to the 45° rotation of the Faraday rotator, other configurations utilizing other amounts of rotation are within the scope of this disclosure. For example, in some embodiments, an optical isolator stabilized laser optical particle counter systems comprises a two stage optical isolator. The two stage optical isolator may comprise three polarizers and two Faraday rotators, with the Faraday rotators sandwiched between the polarizers.

### EXAMPLE 3—POLARIZATION INDEPENDENT ISOLATORS

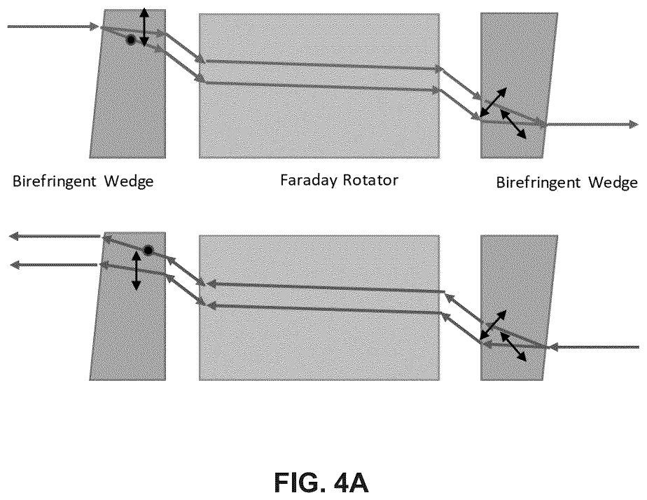

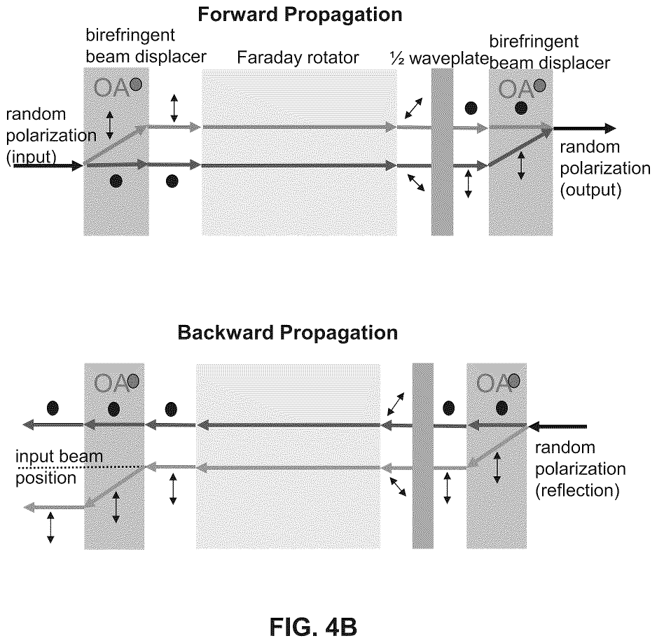

In some embodiments, a polarization independent isolator may comprise an input birefringent wedge, a Faraday rotator, and an output birefringent wedge. In the example of FIG. 4A, the input birefringent wedge is depicted with its ordinary polarization direction as vertical and its extraordinary polarization direction shown as horizontal. In the example of FIG. 4A, the output birefringent wedge is depicted with its ordinary polarization direction at 45° and its extraordinary polarization direction at −45°.

As shown in FIG. 4A, light traveling in the forward direction is split by the input birefringent wedge into its vertical (0°) and horizontal (90°) components, referred to as the ordinary ray (o-ray) and the extraordinary ray (e-ray) respectively. The Faraday rotator rotates both the o-ray and e-ray by 45°. This means the o-ray is now at 45°, and the e-ray is at −45°. The output birefringent wedge then recombines the two components.

Light traveling in the backward direction is separated into the o-ray at 45, and the e-ray at −45° by the birefringent wedge. The Faraday Rotator again rotates both the rays by 45°. Now the o-ray is at 90°, and the e-ray is at 0°. Instead of being focused by the second birefringent wedge, the rays diverge. Thus, light traveling in the upstream direction may be highly attenuated and the stability of the source laser may be improved.

In some embodiments, first and second collimators are may be used, one on either side of the isolator. In such embodiments, in the transmitted direction the beam is split and then combined and focused into the output collimator. In the isolated direction the beam is split, and then diverged, so it does not focus at the collimator.

While the optical isolator of FIG. 4 is depicted as a single stage optical isolator, other embodiments are within the scope of this disclosure. For example, in some embodiments, the optical isolator may be a multistage polarization independent optical isolator. In one example, a two-stage polarization independent optical isolator may comprise two single stage isolators such as that shown in FIG. 4 disposed in series along the path of the beam.

### EXAMPLE 4—RANDOMLY POLARIZED LASER LIGHT SOURCE

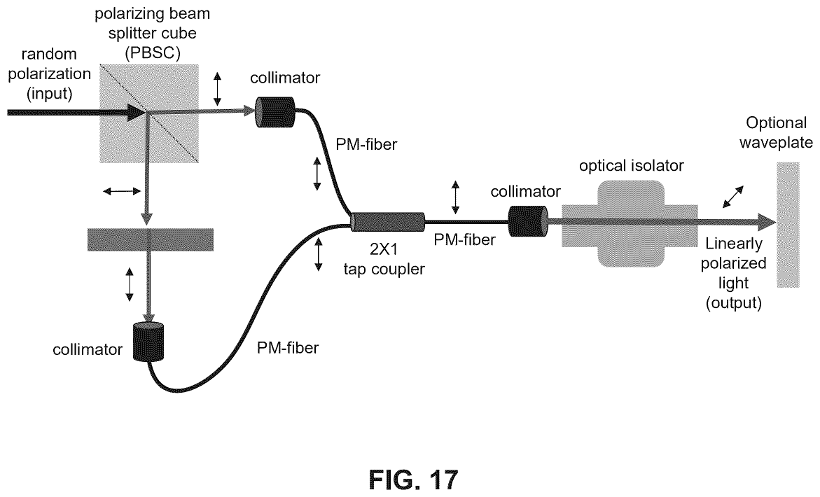

As described above, a Faraday isolator may be used with linearly polarized laser sources, as its input polarizer rejects the orthogonal polarization; however, as shown in FIG. 17, a randomly polarized laser source can be well configured via beam combining to deliver a linearly polarized beam with a Faraday isolator integrated for the output beam. Faraday isolators can be used for each orthogonally polarized laser beam without beam combining techniques afterward. It should be noted that integration of a Faraday isolator in a particle counter instrument is not limited to the specific input or output polarization orientation depicted in FIGS. 2-3 or the particular beam combining technique for a randomly polarized laser source shown in FIG. 4B.

### EXAMPLE 5—OPTICAL ISOLATOR STABILIZED LASER OPTICAL PARTICLE COUNTER SYSTEM

In embodiments preferred for some applications, the optical isolator may be positioned between the laser and the first optical element. It has been found that such a configuration may provide improved stability due to the minimization of index of refraction interfaces and/or potentially contaminated optical element surfaces upstream of optical isolator.

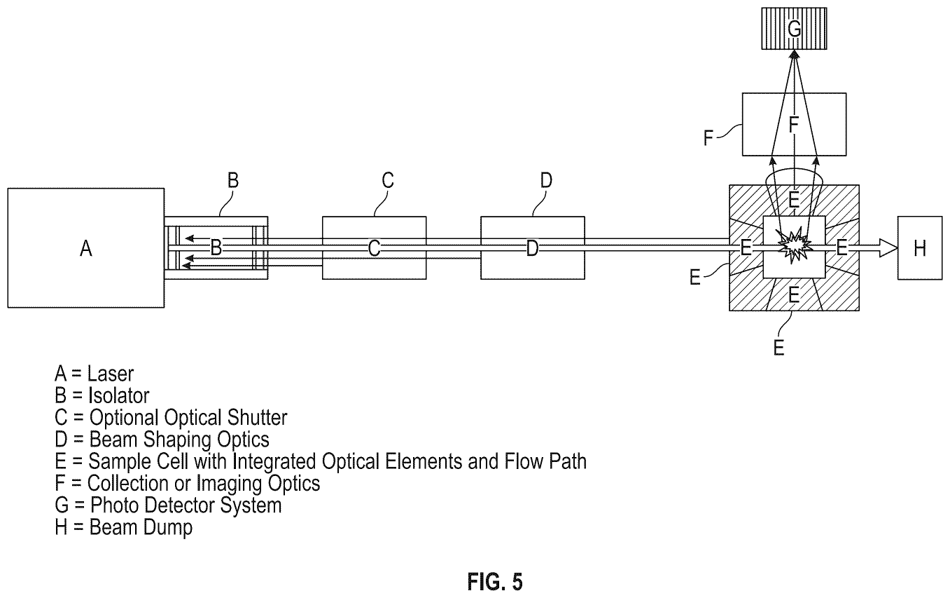

Turning now to FIG. 5, one such system is illustrated. As can be seen in FIG. 5, the system is configured with the optical isolator proximal the laser source and upstream of any other optical component in the system. In operation, light emitted from the laser may be transmitted though the optical isolator with high transmission, such as a transmission great than or equal to 50%, optionally, greater than or equal to 70%. Downstream of the optical isolator, the light may pass through an optional optical shutter before passing though one or more beam shaping optical elements. Then the shaped beam may be focused in the particle interrogation zone, in this case, a sample cell with integrated optical elements and a flow path for fluid to be analyzed for particles. Scattered light from particle/beam interactions in the particle interrogation zone and/or source light from the laser may be detected by one or more photodetectors. Unscattered light may be directed to a beam dump to reduce the amount of reflected or backscattered light propagating in the upstream direction.

As can be seen, the system of FIG. 5 includes numerous potential sources of backscattered or reflected that, absent the optical isolator, could make its way back into the laser and cause signal noise. These sources include the index of refraction interfaces at each surface/fluid boundary, potential contamination on any of the optical elements, and molecular scatter from the fluid flowing in the sample cell. Thus, the system of FIG. 5 achieves improved performance over conventional particle detector systems by incorporation of the optical isolator characterized by a low transmission of light from scattering and/or emission involving the downstream system elements, such as beam shaping and/or direction optics (e.g., lenses, apertures, prisms, filters, mirrors, beam splitters, dispersing elements, etc.), elements of the particle interrogation zone (e.g., surfaces of the flow cell, windows, apertures, etc.), imaging optics, beam stops, detectors, etc., for example, a transmission less than or equal to 10%, optionally less than or equal to 5%.

As shown in the embodiment of FIG. 5, the optical isolator is the first optical element downstream of the laser source. As discussed above, it has been discovered that keeping the beam path between the laser source and the optical isolator free of optical elements may provide the greatest benefit in reduction of feedback to the laser. Furthermore, it may be advantageous to configure the system such that the beam path between the window of the laser source and the optical isolator is short, for example less than 500 mm, or optionally less than 300 mm.

In one embodiment there is no focusing element between the laser source and the optical isolator. In one embodiment, there is no polarizing element between the laser source and the optical isolator. In one embodiment there is no collimating element between the laser source and the optical isolator.

Alternatively, in some embodiments, the optical isolator can be integrated into the laser housing itself just inside the optical window or downstream of the laser power control detection circuit.

While the system of FIG. 5 is depicted as having a single laser and a single optical isolator, in some embodiments, optical isolator stabilized laser optical particle counter systems may include multiple lasers and/or multiple optical isolators. For example, in one embodiment, a particle detector system may include two lasers, each with their own optical isolator.

### EXAMPLE 6—STATE CHANGING ISOLATOR

In some embodiments, in particular when the particle detection system and/or method can tolerate circularly polarization in the sampling region, then the combination of a polarizing beam splitter cube (PBS) and a quarter-wave plate can be arranged to prevent laser light from returning along the outbound path.

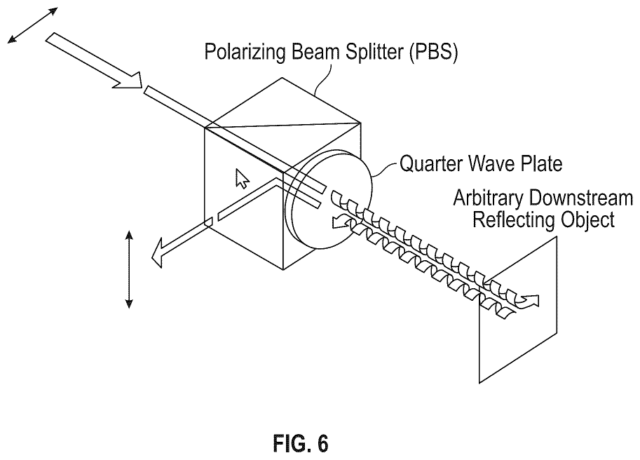

Turning now to FIG. 6, one such embodiment is shown. In the illustrated embodiment of FIG. 6, the laser beam enters the cube with P-plane polarization, which enables it to pass through the beam-splitter junction and into the quarter-wave plate. With the fast axis of the quarter-wave plate oriented at 45 degrees the incident linear beam polarization becomes right hand circular (RHC). Then, if any objects are encountered by the beam there will be reflected light, and for light that reflects back into the original direction its polarization will undergo a 180-degree phase change, and becomes left hand circular (LHC). Upon passage back through the quarter-wave plate the LHC light becomes S-plane linear and is redirected out of the PBS and into a beam dump. In this way laser light is prevented from getting back to its source.

### EXAMPLE 7—ACOUSTO-OPTIC ISOLATOR

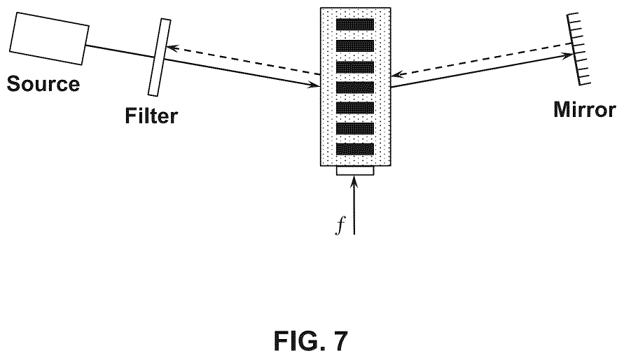

In some embodiments, an acousto-optic cell can serve as an isolator. Turning now to FIG. 7, one embodiment of an acousto-optic isolator is shown. In the illustrated embodiment, part of the frequency-upshifted Bragg-diffracted light is reflected onto itself by a mirror and traces its path back into the cell, it then undergoes a second Bragg diffraction accompanied by a second frequency upshift. Since the frequency of the returning light differs from that of the original light by twice the sound frequency, a filter may be used to block it. Alternatively, the filter may be eliminated for those applications and/or methods wherein the detection process is insensitive to the frequency-shifted light.

### EXAMPLE 8—CONTROL OF ACTIVELY STABILIZED LASER PARTICLE DETECTOR SYSTEMS

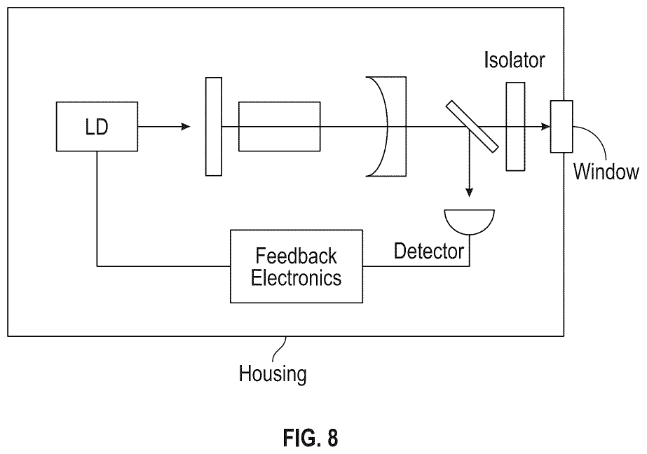

In some embodiments, the laser optical source of the particle detection system is an actively stabilized laser. Turning now to FIG. 8, a schematic diagram of one example of such an actively stabilized laser is shown. In the illustrated embodiment, a solid-state laser produces a beam which is sampled by a photodetector (i.e., a separate photodetector than the one or more photodetectors of the particle detection system). The detector is in electronic communication with a controller. The controller analyzes the signal from the photodetector and adjusts the power of the laser (via, for example, control of the pump power or control of the losses in or outside the laser resonator) to stabilize the output power of the laser.

In particle detection systems, optical feedback from the particle detection may travel back to the laser, as described above. Such feedback may be particularly deleterious to the operation of an actively stabilized laser particle detection system because the feedback may be detected by the photodetector and cause a false adjustment to the laser system. This may trigger a cyclic instability behavior in the system, wherein optical feedback returning into the laser system is picked up by the beam power control loop, the controller erroneously responds by lowering the power, the optical feedback momentarily ceases, the controller senses a drop in beam power and responds by increasing laser power, the optical feedback returns and the cycle repeats, causing the power of the beam to be highly destabilized.

Thus, as can be seen in FIG. 8, in some embodiments the actively stabilized laser of a particle detection system may include an optical isolator. The optical isolator may be an integral part of the laser system, i.e., the optical isolator may be disposed inside the housing of the laser system, with the beam sampling occurring prior to the beam exiting the exit window of the laser system.

Accordingly, in one embodiment, a method of controlling an actively stabilized laser particle detection system comprises producing a beam of electromagnetic radiation via the actively stabilized laser. The beam power may be monitored via a beam power sampling photodetector. The beam power may be adjusted via a controller using input from the beam power sampling photodetector. The beam may pass through an optical isolator, either prior to exiting the window of the laser system or very close in distance after the window. The beam may then be shaped via one or more beam shaping elements and directed toward a particle interrogation zone. The beam may interact with the particles in the particle interrogation zone. Due to any of the factors discussed above, light may be transmitted from the particle detection system back toward the laser. The light traveling back to the laser may be filtered via an optical isolator, preventing or reducing the instability caused by the feedback loop.

While the embodiment of FIG. 8 depicts the controller and the beam power monitoring photodetector inside the housing of the actively stabilized laser, in other embodiments, the controller and/or the beam power monitoring photodetector may be placed outside the housing.

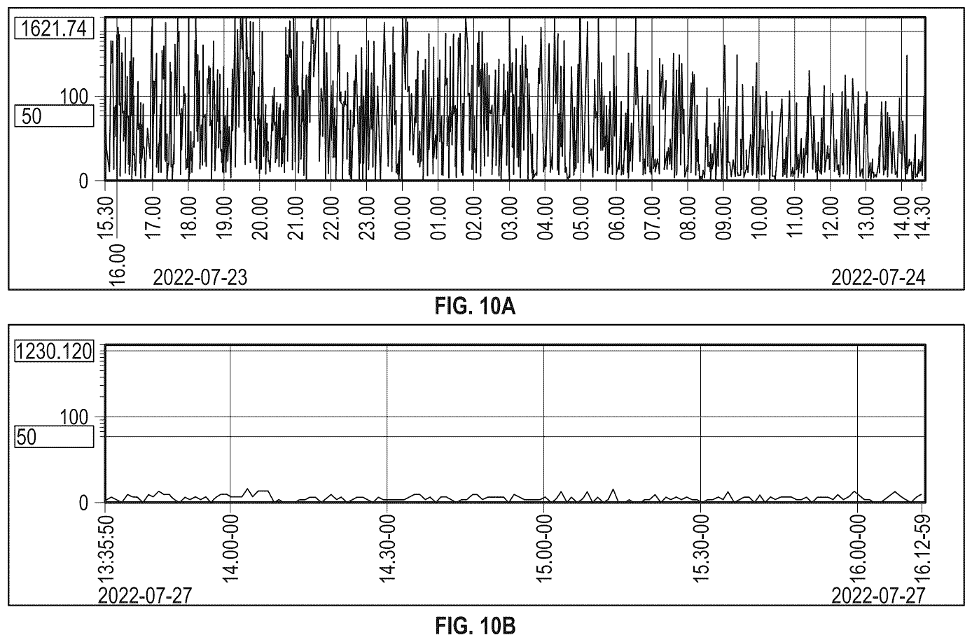

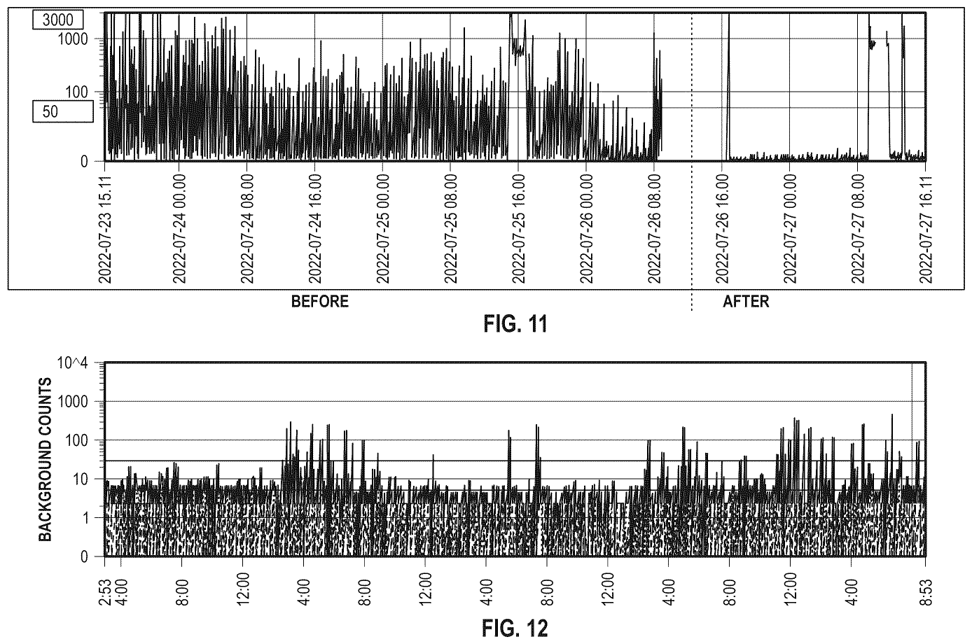

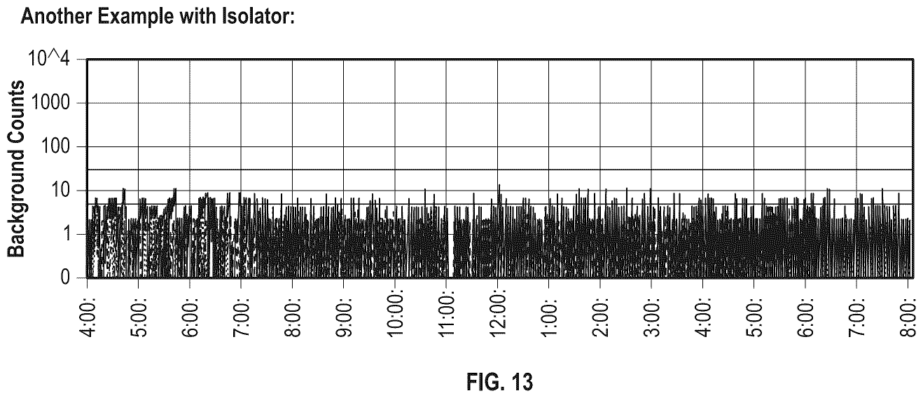

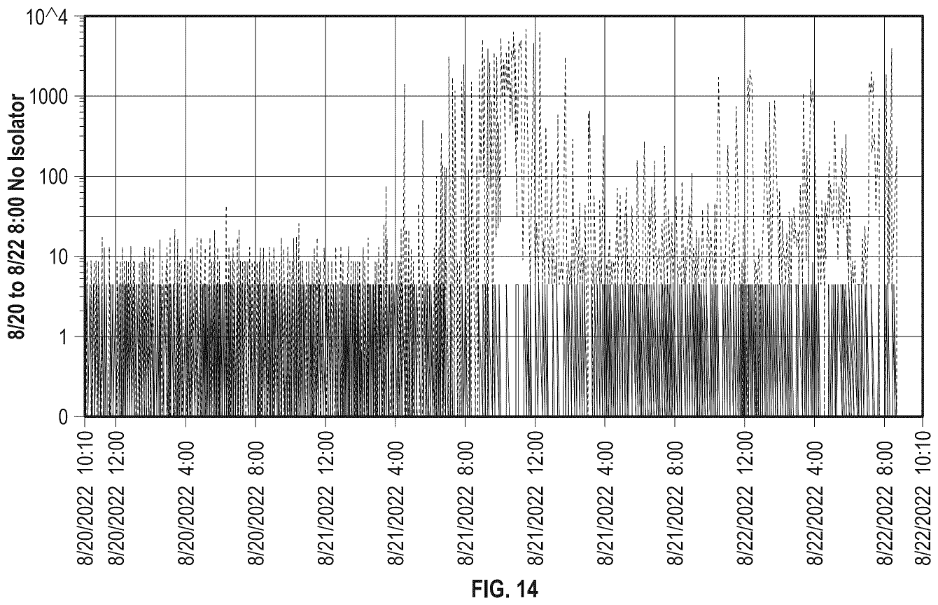

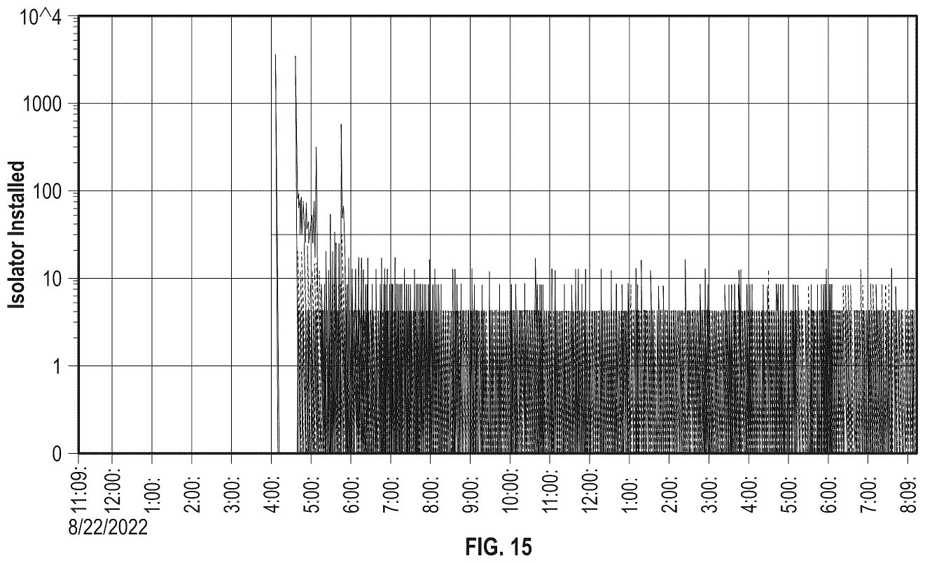

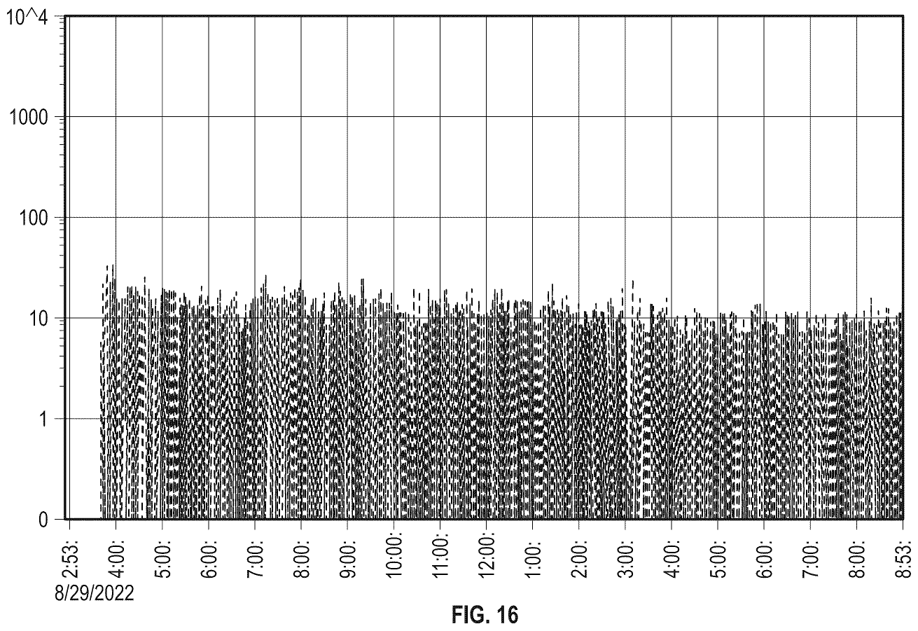

Turning now to FIGS. 10A-16, several examples are shown of the behavior of actively stabilized laser particle detection systems with and without an optical isolator are shown. For example, FIG. 10A is a plot of detected particle count vs. time. The plot shows numerous false positive detection events occurring in rapid succession. A Faraday optical isolator was installed on the device and, as shown in FIG. 10B, the false positive detection behavior of the device ceases in response to the installation of the optical isolator. Similarly, FIG. 11 shows numerous false positive detection events occurring, until a Faraday rotator is installed, at which point the false positive behavior of the device ceases. FIG. 12 shows numerous false positive detection events until a Faraday optical isolator is installed and the false positive behavior ceases, as shown in FIG. 13. FIG. 14 shows numerous false positive detection events until a Faraday optical isolator is installed and the false positive behavior ceases, as shown in FIG. 15. FIG. 16 shows continued operational stability of the device and the absence of significant false positive detection events.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1-51. (canceled)

52. A method of reducing false positive detection events in a particle detection system wherein the method comprises:
producing a beam of electromagnetic radiation via an actively stabilized laser, the laser having a laser power of 300 milliwatts to 100 watts; wherein the particle detection system is configured to have a lower detection limit of 5 nm to 50 nm effective particle diameter; and
passing the beam through an optical isolator;
shaping the beam via one or more beam shaping elements;
directing the shaped beam toward a particle interrogation zone,
passing particles through the particle interrogation zone, wherein the beam interacts with the particles in the particle interrogation zone;
detecting at least a portion of light scattered and/or transmitted from the particle interrogation region via a first photodetector;
monitoring the beam power via a second photodetector;
filtering, via an optical isolator, optical feedback from the particle detection system out of an optical path leading to the second photodetector; and
controlling the laser power via a feedback control loop, the feedback control loop comprising a controller and a second photodetector; and
reducing false positive detection events in the particle detection system in response to the filtering step.

53. The method of claim 52, wherein the optical isolator provides for a transmission of reflected, scattered or emitted light from the system to the laser optical source of less than or equal to 10%.

54. The method of claim 52, wherein the optical isolator provides for a transmission of said beam of electromagnetic radiation from the laser optical source greater than or equal to 50%.

55. The method of claim 52, wherein the optical isolator comprises a Faraday rotator.

56. The method of claim 52, wherein the optical isolator is free standing or integrated into a housing of the laser optical source.

57. The method of claim 52, wherein the optical isolator is a polarization dependent optical isolator.

58. The method of claim 52, wherein the optical isolator comprises an input polarizer, a Faraday rotator and an output polarizer; wherein the input polarizer is positioned between the laser optical source and the Faraday rotator and the output polarizer is positioned between the Faraday rotator and the particle interrogation zone.

59. The method of claim 58, wherein the Faraday rotator provides for nonreciprocal rotation while maintaining a linear polarization of said beam of electromagnetic radiation.

60. The method of claim 58, wherein the Faraday rotator rotates the plane of polarization of the beam of electromagnetic radiation by 45° to 90°.

61. The method of claim 58, wherein the output polarizer is configured to transmit the beam of electromagnetic radiation passing from the Faraday rotator toward the particle interrogation zone.

62. The method of claim 58, wherein the input polarizer is configured to prevent transmission of light passing from Faraday rotator toward the laser optical source.

63. The method of claim 58, wherein the optical isolator is a polarization independent optical isolator.

64. The method of claim 52, wherein the optical isolator comprises an input birefringent wedge, a Faraday rotator and an output birefringent wedge; wherein the input birefringent wedge is positioned between the laser optical source and the Faraday rotator and the output birefringent wedge is positioned between the Faraday rotator and the particle interrogation zone.

65. The method of claim 64, wherein the input birefringent wedge is configured to split the beam from the laser optical source into a first component beam and second component beam, wherein the first component beam corresponds to the vertical component of the beam and the second component beam corresponds to the horizontal component of the beam; and the output birefringent wedge is configured to recombine the first and second component beams after passing through the Faraday rotator.

66. The method of claim 64, wherein the Faraday rotator is configured to rotate the planes of polarization of the first and second component beams.

67. The method of claim 52, wherein a first collimator positioned between the optical isolator and the laser optical source and a second collimator position between the optical isolator and the particle interrogation zone.

68. The method of claim 52, wherein the laser optical source is a solid state laser.

69. The method of claim 52, wherein the laser optical source is a laser diode or laser oscillator.

70. The method of claim 52, wherein the laser optical source provides randomly polarized light.

71. The method of claim 52, wherein a half wave plate is disposed in the path of the beam after the optical isolator to restore the polarization of the beam.

72. The method of claim 52, wherein the photodetector comprises one or more two dimensional photodetector arrays.

73. The method of claim 52, wherein the laser optical source has an exit window, and wherein the beam path between the window and the optical isolator is less than 300 mm.
